(19) United States
(12) Patent Application Publication
(10) Pub. No.: US 2017/0291287 A1
(43) Pub. Date: Oct. 12, 2017

(54) Wrench and Ratchet Adapter

(71) Applicant: Daniel M. Bendix, Lake Zurich, IL (US)

(72) Inventor: Daniel M. Bendix, Lake Zurich, IL (US)

(21) Appl. No.: 15/282,286

(22) Filed: Sep. 30, 2016

Related U.S. Application Data
(60) Provisional application No. 62/320,820, filed on Apr. 11, 2016.

(51) Int. Cl. B25B 13/48; B25G 1/00; B25B 13/46; B25B 23/00; B25B 27/00; B25G 1/04; B25G 1/06

(52) U.S. Cl. CPC B25B 13/481; B25G 1/043; B25G 1/005; B25G 1/063; B25B 23/0007; B25B 27/0035; B25B 13/462

(57) ABSTRACT

A customized tool adapter that allows for a typical wrench to be connected temporarily, but with great stability to a typical ratchet. Such an application is capable of being used with several types wrenches and ratchets, including various sizes, units of measurement and other applications and is generally hexagonal in nature having swaged gripping lips.

### BACKGROUND OF THE INVENTION

### Field of the Invention

The present invention generally relates to a nut-type adapter for wrenches. More particularly, the present invention relates to a tool designed to be installed between a combination wrench with both an open end and/or a closed end and make the connection to a ratchet. This effectively allows a safe connection between the tools and extends the length of the ratchet resulting in: A) Increased torque; and/or B) Extended range and mobility of the ratchet. This replaces several, crude methods of extending the length of wrenches and ratchets that do not give the user control over the tools or are bulky and cumbersome, limiting their use in certain applications.

### Discussion of the Prior Art

U.S. Pat. No. 4,971,502 ('502 Patent), which issued to OH, discloses a Fastening Bolt Set. The '502 Patent describes fastening bolt set which is used for attaching an object to a structure, and which comprises an ordinary bolt with a hexagonal or circular head, an internal washer having a long shape and having an annular projection, an external washer having an annular projection, and an ordinary nut for final tightening, all of the above components being connected by a string. This device is used where the back side of the structure is unreachable by hand or by means of a tool, and the working method is such that the bolt and the internal washer are sequentially inserted through the fastening hole, and the string connected to the bolt and the washer is pulled out of the fastening hole. Then the head of the bolt and the internal washer are combined together, the body of the bolt is passed through the fastening hole, and the head of the bolt and the internal washer are halted at the back side of the fastening hole. Then the external washer and the nut are put to the outwardly extended bolt body to finish the fastening by tightening the nut.

U.S. Pat. No. 5,080,546 ('546 Patent), which issued to Purvin et al. discloses a Two Piece Cradle Nut. The '546 Patent essentially describes two piece fastener made up of a hex-on-hex nut and a diamond shaped steel plate with a countersink portion having a hex shaped hole to receive the reduced across flats portion of the hex-on-hex nut. The bottom of the nut sits above the thin metal bearing surface against which the steel plate is being clamped.

U.S. Pat. No. 5,518,351 ('351 Patent), which issued to Peil, discloses a Self-Tapping Screw Having Threaded Nut as a Head. The '351 Patent describes an article of manufacture consisting of a self-tapping screw with a hex nut, joined to the head thereof where the hex nut including an internally threaded central bore, is used to facilitate the suspension of water pipes from a ceiling member in a building. The article can be inserted into the ceiling surface by first inserting the hex head into a socket which is affixed to the chuck of an electric drill. When the drill is energized, the self-tapping screw drills into or through the ceiling surface. Now, when the article is pulled free from the drill-mounted wrench socket, a threaded rod may be screwed into the hex nut for suspending a pipe cradle.

U.S. Pat. No. 9,212,682 ('682 Patent), which issued to Yamazaki, describes a Fastening Member. The '692 Patent describes a fastening member for appropriately ensuring strength of a peripheral edge part of a tapered-ring-body-shaped part and appropriately reducing external dimensions. A bolt, a nut or a washer employed for fastening a body is fastened by a screw tightening action The fastening member has a tapered-ring-body-shaped part formed into a ring body shape with a gradually increasing diameter toward a seating surface formed into a circular-planar-band-ring-shape concentric with an axis so as to press against the body being fastened. The taper angle of the tapered-ring-body-shaped part is an acute angle, and an upright surface is formed on an outer circumferential surface of the tapered-ring-body-shaped part and vertically erected from the body being fastened.

### SUMMARY OF THE INVENTION

A difficulty in the automotive industry is that traditional wrenches, ratchets, and other tools are not available in lengths long enough to exert the appropriate levels of torque on a both that has been in place for several years and often has oxidized in place. Additionally, even if longer tools were available, they would be straight, niche, expensive, and cumbersome, and thus the problems presented would not be significantly reduced. Often times mechanics will use a large pipe to extend the reach of a tool, but that sacrifices much of the dexterity of the user, and also causes issues with the ability to see what one is working on. Thus, there is a need for the ability to extend the range of tools, particularly wrenches and ratchets, both to generate torque and extend the reach of the user. Therefore, the present invention relates to a customized adapter that allows for a typical wrench to be connected temporarily, but with great stability to a typical ratchet.

Such an application is capable of being used with several types wrenches and ratchets, including various sizes, units of measurement and other applications. Typical uses will involve connections between ⅜″, ½″ and ¾″, but larger and smaller applications are also anticipated by this device. Indeed, a major advantage of the adapter design of the current invention is its universal applicability and adaptability to a wide range of tools and applications for mechanics, carpenters, plumbers, and in a number of other trades contemplated, but not explicitly recited.

To achieve this result the current adapter has several unique features that result in a more stable connection between tools. Firstly, the adapter resembles a typical hex-nut (or another commonly shaped nut) which is used universally in the trades. This allows for a plurality of tools to be connected using a single size. The adapter also uses a typical rounded-rectangular interior that is commonly used in ratchet applications in concjuntion with a circular cut-out that allows for a tool to be locked into place. Importantly the edges of the nut are swaged (or pressed) to create a lip that can latch onto the closed of a typical combo wrench (although it is also capable of being affixed to the open end). Lastly, to accommodate a great number of tools, it is contemplated that several sizes and shapes of the adapter can be manufactured and placed into a single kit, or individualized, custom adapters, can also be manufactured upon request.

To achieve these objectives, a wrench and ratchet adaptor, methods, and tools having the following features is proposed.

A combination ratchet, wrench, and adapter comprising at least a ratchet, the ratchet comprising a handle and a ratcheting end, the ratcheting end comprising a male socket interface, a wrench, the wrench being a combination wrench having one open end and one closed end, an adapter, the adapter comprising a nut having at least a top face, a bottom face, and at least four outer sides being perpendicular to and spanning the top face and bottom face, a centrally located female socket interface spanning the top face and the bottom face, the female socket interface matable with the male socket interface of the ratchet, the walls of the central cut being parallel to the at least four outer sides, the at least four outer sides forming parallel edges therebetween, and at least four lips located at the intersection of the top face and the parallel edges, the outer sides and parallel edges being matable with at least the closed end or the open end of the wrench; the lips protruding outwards from the edges such that the cross sectional diameter of the outermost portion of the edges is greater for the top face than the bottom face, wherein the female socket interface of the adapter is mated with the male socket interface of the ratchet and the outer sides of the adapter are mated with one of: the open end of the wrench, or the closed end of the wrench.

In certain embodiments the adapter comprises six, equally sized outer sides and six lips located at the intersection of the top face and the parallel edges. In certain cases adapter is mated to the closed end of the wrench with the six sides contacting the interior portion of the closed end of the wrench and the six lips contacting the outer edge of the closed end of the wrench located opposite the ratchet, thereby preventing the wrench from sliding along an axis parallel to the sides of the adapter in the direction away from the ratchet, locking the wrench in place. In other embodiments the adapter is mated to the open end of the wrench with the six sides contacting the interior portion of the open end of the wrench and the six lips contacting the outer edge of the open end of the wrench located opposite the ratchet, thereby preventing the wrench from sliding along an axis parallel to the sides of the adapter in the direction away from the ratchet, locking the wrench in place along said axis, but allowing removal of the wrench along an axis perpendicular thereof. In certain embodiments the male socket interface further comprises a rounded ball for locking and the adapter comprises at least one hole spanning at least one of the at least four outer sides to a wall of the female socket interface, the at least one hole matable to the rounded ball. In other embodiments the rounded ball of the male socket interface is mated with at least one of the at least one hole of the adapter, thereby preventing rotation and slipping of the adapter with respect to the male socket interface of the ratchet, and the adapter is mated to the closed end of the wrench with the six sides contacting the interior portion of the closed end of the wrench and the six lips contacting the outer edge of the closed end of the wrench located opposite the ratchet, thereby preventing the wrench from sliding along an axis parallel to the sides of the adapter in the direction away from the ratchet, locking the wrench in place.

In another embodiment the current invention comprises a tool adapter comprising, a nut having at least a top face, a bottom face, and at least four outer sides being perpendicular to and spanning the top face and bottom face, a central rounded rectangular cut from the nut spanning the top face and the bottom face, the walls of the central cut being parallel to the at least four outer sides, at least one hole spanning at least one of the at least four outer sides to the wall of the central cut, the at least four outer sides forming parallel edges therebetween, and at least four lips located at the intersection of the top face and the parallel edges, the lips protruding outwards from the edges such that the cross sectional diameter of the outermost portion of the edges is greater for the top face than the bottom face.

In some embodiments the at least four lips are swaged. In other embodiments at least six outer sides and at least six lips. In some the at least six sides are substantially identical in size and the angles between said sides are substantially the same. In other embodiments the central rounded rectangular cut is a female socket interface. Other times the at least eight outer sides and at least eight lips.

In a third embodiment the invention contemplates a method for manufacturing a tool adapter having at least the steps of, providing a six sided die cast nut having a top face and a bottom face and a female connection fitting at a centrally located location spanning between the top face and bottom face, providing an instrument having six interior surfaces matable to the exterior sides of the six sided die cast nut, orienting the instrument such that the interior sides of the instrument are offset from the sides of the die cast nut by approximately thirty degrees, thereby orienting the interior sides of the instrument with the edges of the six sided die cast nut, pressing the instrument onto the top face of the die cast nut thereby swaging the six edges of the nut into lips, thereby manufacturing the tool adapter.

In some embodiment the method of manufacturing requires that the six sided nut has a hole spanning from one side of the nut to the wall of the female connection fitting. In other cases the female connection fitting is a rounded rectangular shape, and the hole spans from one side of the rounded rectangle to one of the six sides of the nut. In another embodiment the invention contemplates the additional step of milling a hole through at least one of the six sides to a side of the female connection fitting.

Such embodiments do not represent the full scope of the invention. Reference is made therefore to the claims herein for interpreting the full scope of the invention. Other objects of the present invention, as well as particular features, elements, and advantages thereof, will be elucidated or become apparent from, the following description and the accompanying drawing figures.

### BRIEF DESCRIPTION OF THE DRAWINGS

Other features of my invention will become more evident from a consideration of the following brief descriptions of drawings:

FIG. 1 is a perspective view of a preferred adapter according to the present invention.

FIG. 2 is a front elevation view of the preferred adapter of figure no. 1 according to the present invention.

FIG. 3 is a back elevation view of the preferred adapter of figure no. 2 according to the present invention.

FIG. 4 is a side on view of the preferred adapter of figure no. 3 rotated 90 degrees according to the present invention.

FIG. 5a is a top plan view of the preferred adapter of figure no. 1 according to the present invention.

FIG. 5b a top plan view of a second embodiment of the adapter according to the present invention.

FIG. 5c a top plan view of another embodiment of the adapter according to the present invention.

FIG. 6 a bottom plan view of the preferred adapter of figure no. 1 according to the present invention.

FIG. 7 is a perspective view of a typical combination wrench mated at the closed end with the adapter of the present invention.

FIG. 8 is a perspective view of a typical combination wrench mated at the open end with the adapter of the present invention.

FIG. 9 is a side-on view of a typical ratchet mated to the adapter of the present invention.

FIG. 10 is a perspective view of a typical ratchet mated to the adapter of the present invention.

FIG. 11 is a side-on-exploded view of a typical ratchet, combination wrench, and the adapter of the present invention.

FIG. 12 is a perspective view of a typical ratchet, combination wrench, and the adapter of the present invention mated as typically contemplated in the present invention.

FIG. 13 is a bottom-up perspective view of a press-manufacturing process of an exemplary adapter.

FIG. 14 is a side on view of the press-manufacturing process of an exemplary adapter of FIG. 13.

FIG. 15 is a side on view of another step of the press-manufacturing process of an exemplary adapter of FIG. 13.

FIG. 16 is a bottom side view of a step of the press-manufacturing process of an exemplary adapter of FIG. 13.

FIG. 17 is a side on view of another step of the press-manufacturing process of an exemplary adapter of FIG. 13.

FIG. 18 is a side on view of another step of the press-manufacturing process of an exemplary adapter of FIG. 13.

FIG. 19 is a bottom-up perspective view of the completed press-manufacturing process of an exemplary adapter of FIG. 13.

### DETAILED DESCRIPTION OF THE PREFERRED EMBODIMENT

Referring now the drawings with more specificity, the present invention essentially provides a tool adapter for connecting a ratchet and wrench in succession and allowing a user to exert a greater amount of force than is traditionally available to him/her with only the use of a ratchet or wrench alone. In addition the adapter can be modified with several other variables and features discussed below to fit a wide range and variety of tools and sizes.

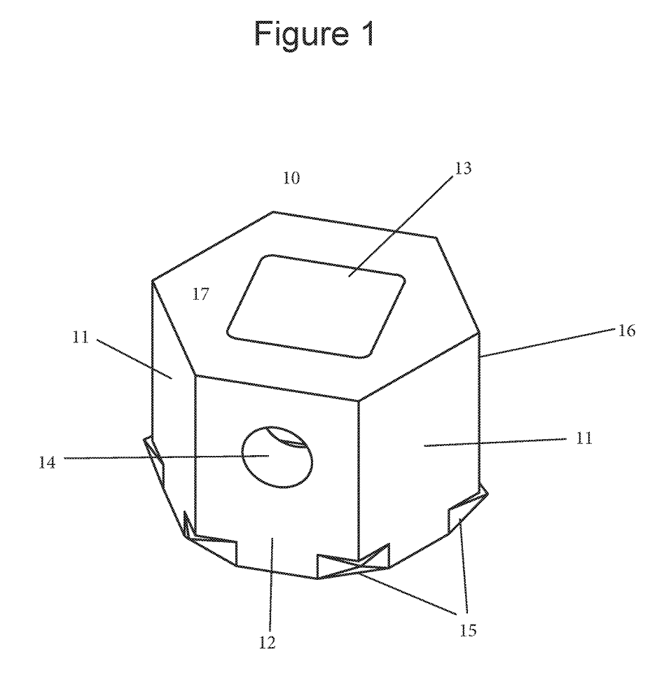

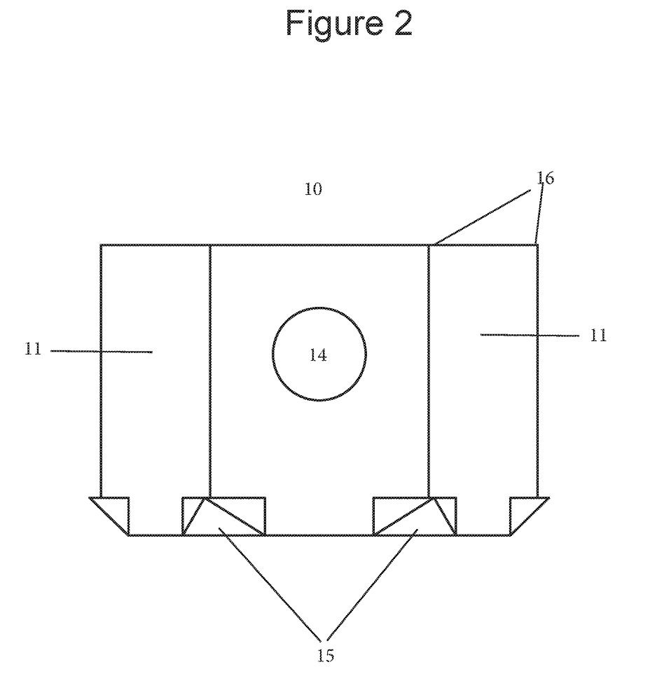

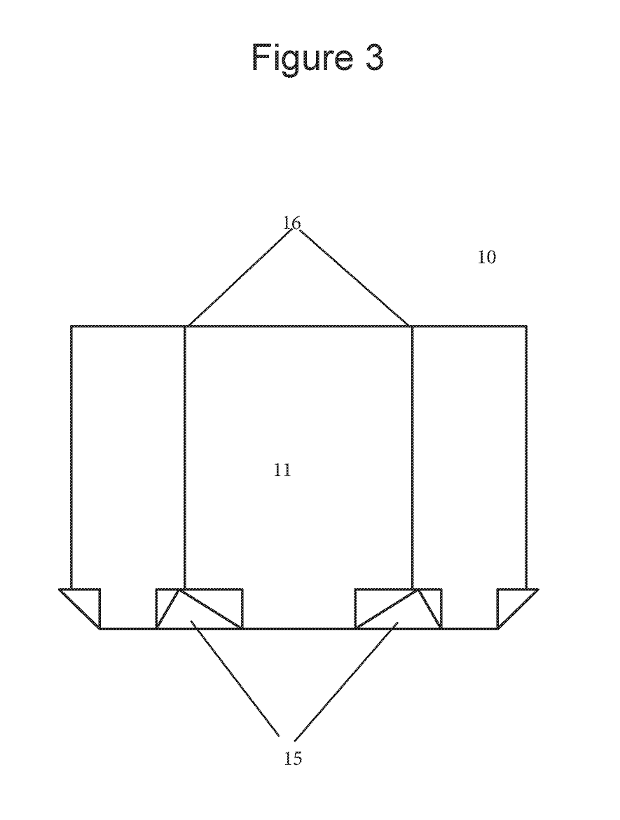

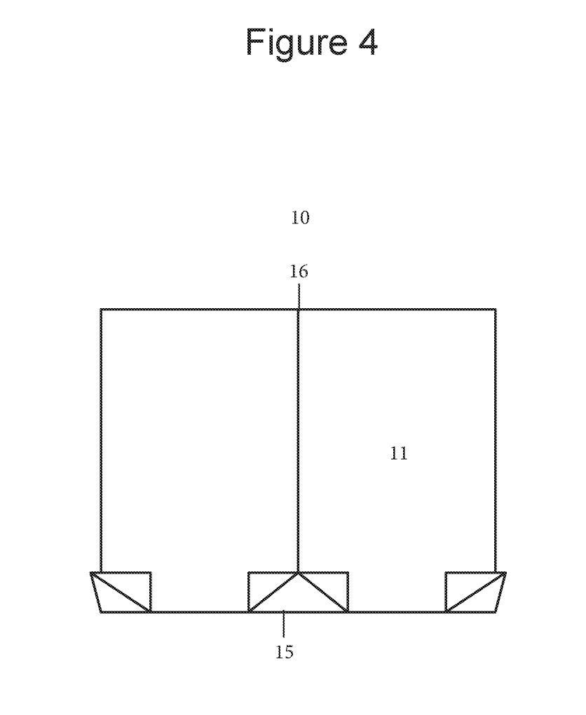

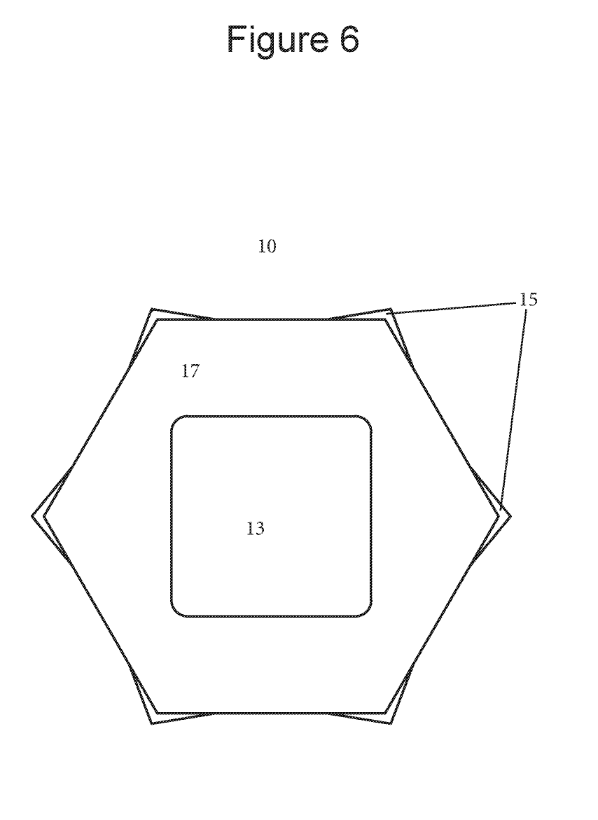

Looking now to FIGS. 1-5a a representative adapter or torque nut 10 is shown. The hexagonal nut, as demonstrated in this figure is a preferred embodiment of the invention. Nut 10 comprises sides 11, the sides comprising at least one face being different from the others 12, center cut 13, bored hole 14, and swaged lips 15. Center cut 13 is typically a rounded square female portion for mating with a rounded square drive. The swaged lips 15 are utilized on at least one, but preferably multiple, edges 16, however are preferably not mirrored onto both sides of the nut 10, as will become clear further below. Thus top face 17 will not contain swaged edges, but bottom face 18 will typically have lips that are capable of gripping a tool as discussed in further detail below. FIG. 6 clearly demonstrates how top face 17 lacks the protruding edges of lips 15 which can be seen emanating from the bottom edge of nut 10 from a top-down perspective.

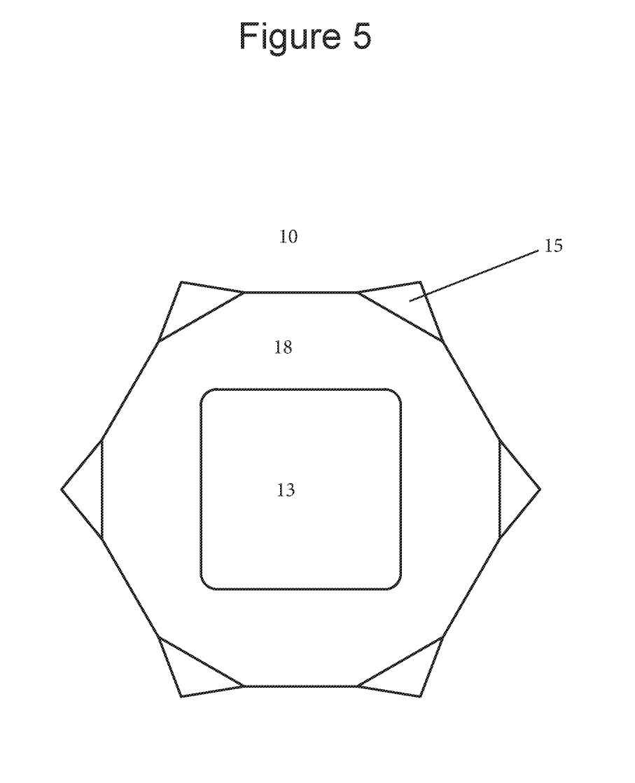

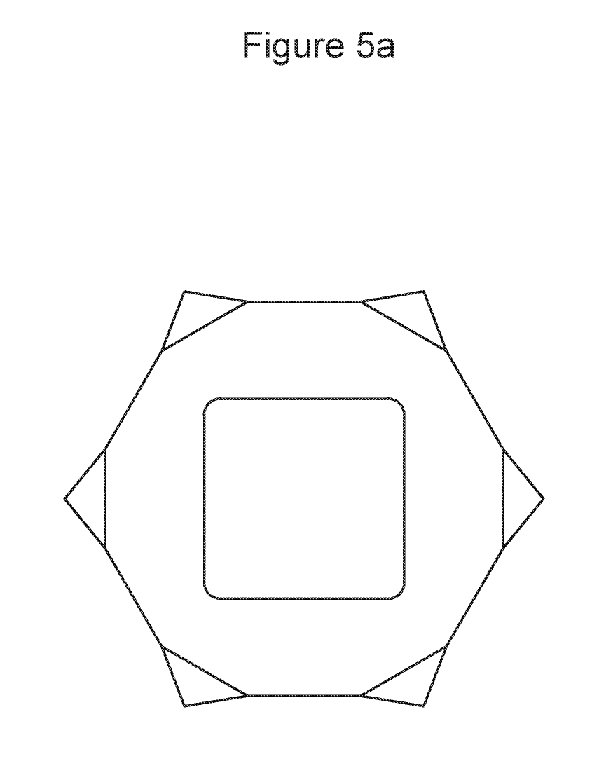

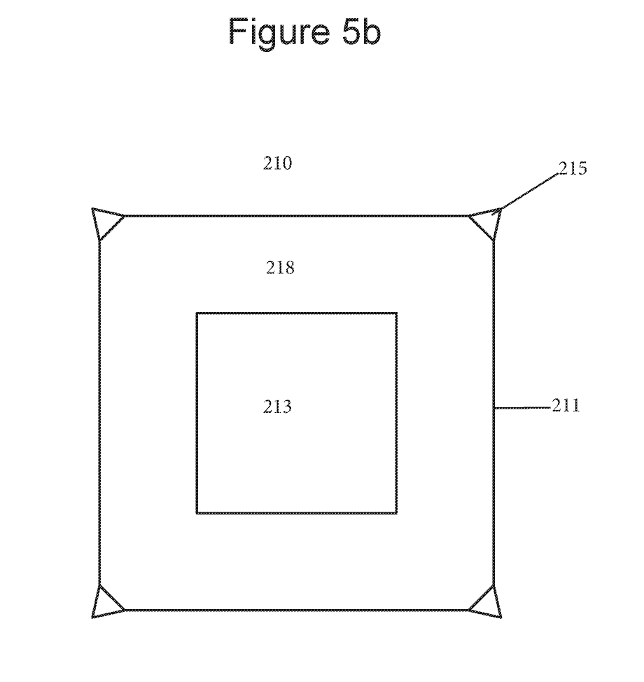

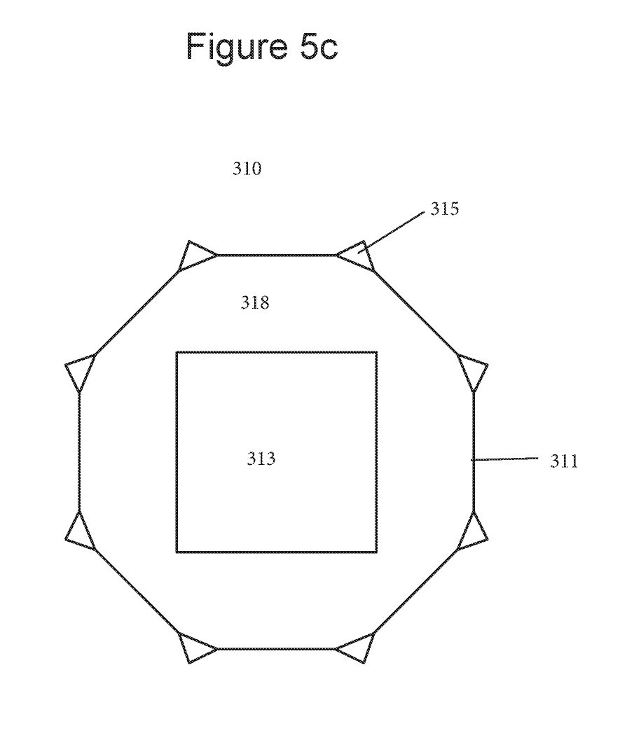

FIGS. 5b and 5c show alternative preferred embodiments 210 and 310 respectively. In FIG. 5b. Nut 210 is a four sided nut is shown from the bottom face 218. As with the hexagonal embodiment, nut 210 has sides 211, cut 213, and swaged lips 215. In FIG. 5c. Nut 310 is an eight sided nut is shown from the bottom face 318. As with the hexagonal embodiment, nut 310 has sides 311, cut 313, and swaged lips 315. Not show, but also present in both the embodiments of FIGS. 5b, 5c are features more clearly shown in the embodiment above such as a bored hold, edges, and a top, unswagged, face. Persons skilled in the art given nut 10 discussed above, along with FIGS. 5b and 5c would be capable of fabricating these additional embodiments.

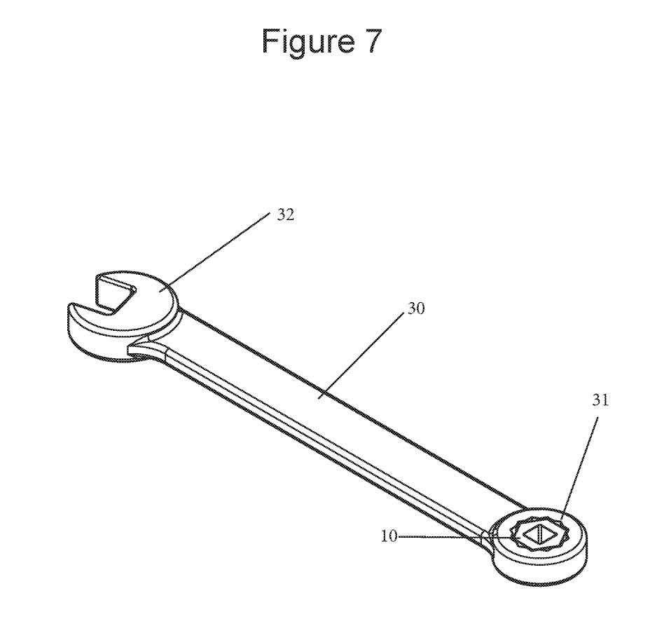

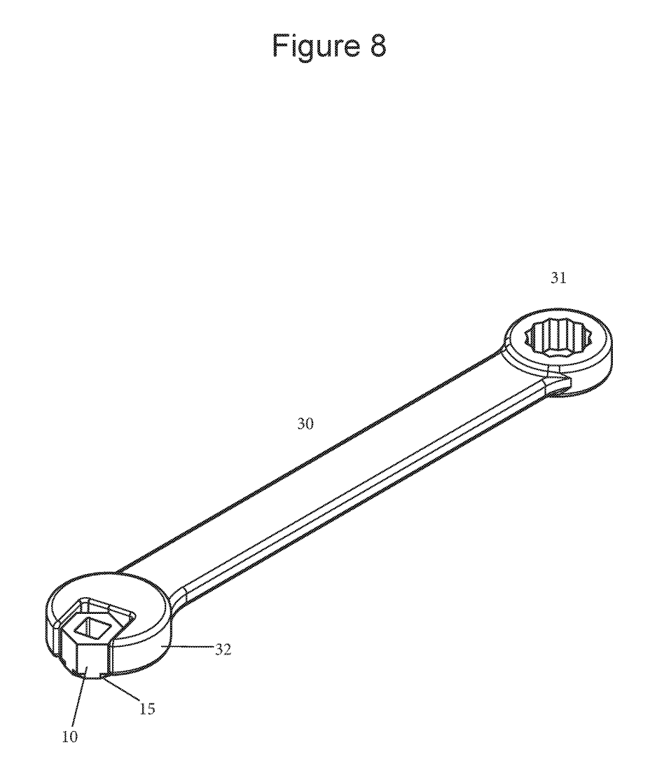

Looking now to FIGS. 7 and 8 adapter or nut 10 is shown in combination with combination wrench 30. In FIG. 7, nut 10 is shown mated with the closed end 31 of combination wrench 30. In certain applications this is the preferred orientation of the nut as it allows for the use of the open end 32 of the combination wrench in whatever project or use is required by the user. In FIG. 8 nut 10 is shown mated with the open end 32 of combination wrench 30. In certain other applications this is the preferred orientation of the nut as it allows for the use of the closed end 32 of the combination wrench. Other combinations with wrenches having two closed, or two open ends, not shown, are also contemplated by this invention.

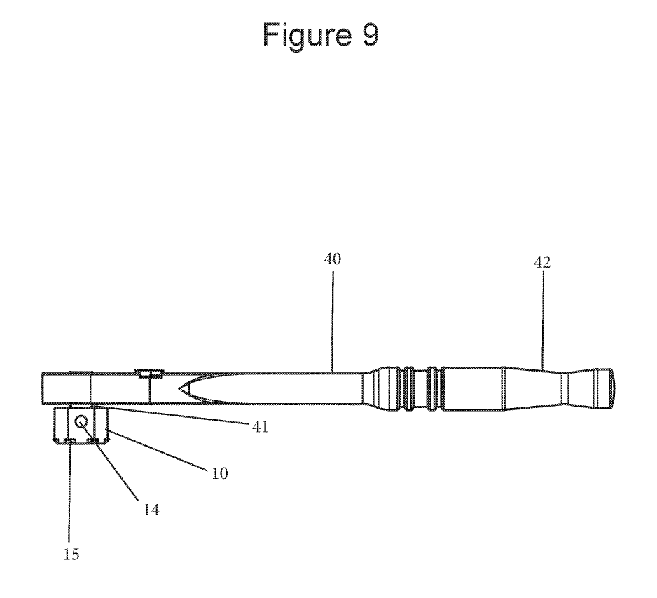

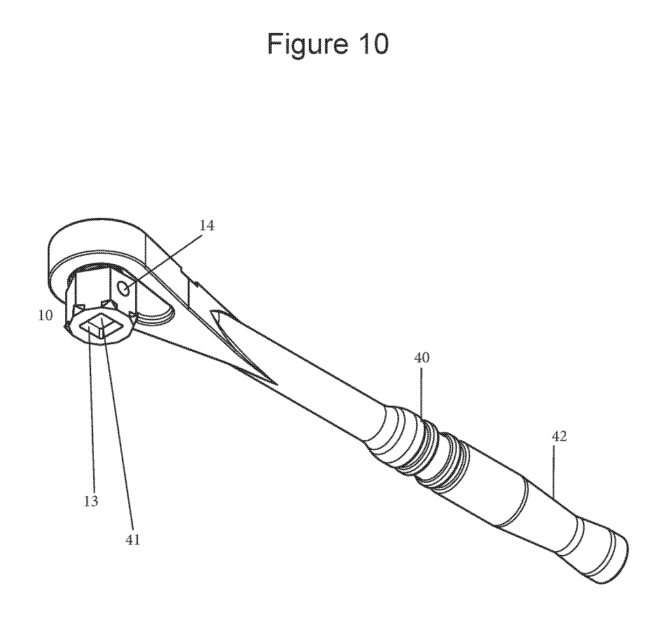

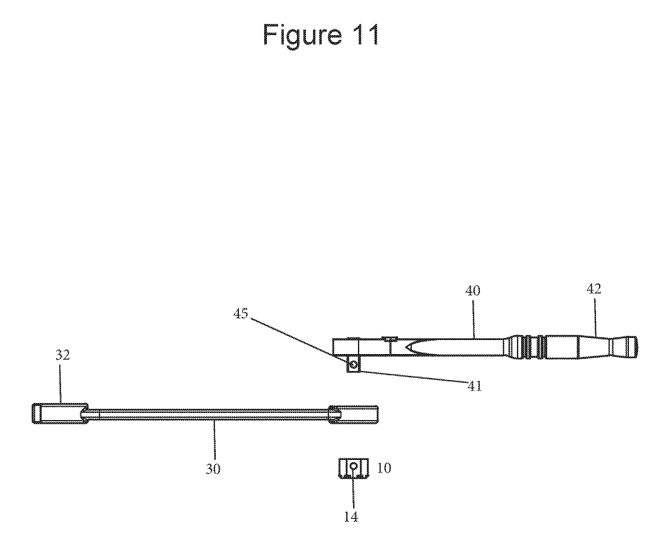

Looking now to FIGS. 9 and 10 adapter or nut 10 is shown in combination with ratchet 40. Ratchet necessarily will have handle 42 and male socket interface 41 is typically a rounded square drive, in some instances it will have a locking pin, or friction ball 44(shown in FIG. 11). Nut or adapter 10 will mate at cut out 13 as with a typical socket onto a ratchet or socket wrench. Typically, the socket wrench or ratchet has a locking pin, or friction ball that will lock into the bored hole 14. Swaged edges 15, in most applications, will face away from ratchet 40 as will become clear below.

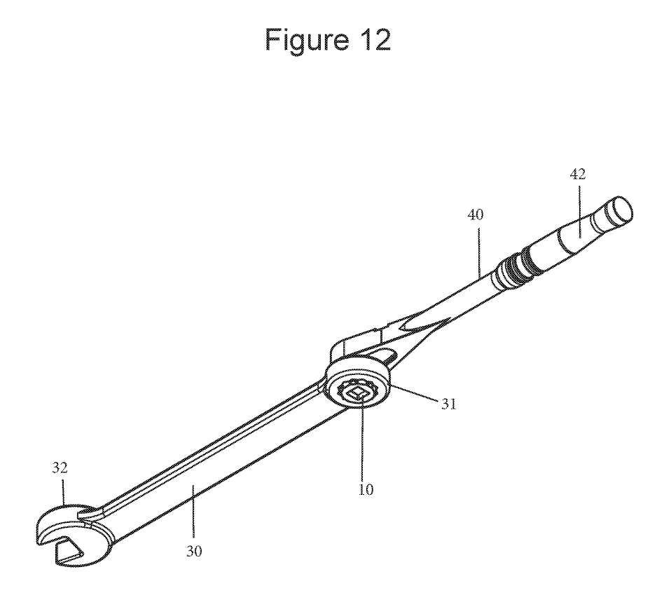

FIGS. 11 and 12 demonstrate an exemplary use of nut 10 in combination with combination wrench 30 and ratchet 40. As becomes clear upon examination of the figures nut 10 fits into closed end 31 (or open end 32 in certain applications) of wrench 30. Square drive 41 of ratchet 40 then fits into cut out 13 of nut 10, and preferably friction ball 45 will lock into bored hole 14. This then creates combined wrench-ratchet-adapter apparatus 60 as shown in Figure no. 12. As can be clearly seen this creates an extension for wrench 30 such that the swaged lips 15 lock the wrench 30 together with the ratchet 40. This larger apparatus 60 has several advantages over a typical wrench. First, it can extend the reach of a wrench, and thus reach additional places, and allows a user to exert extra torque than with a standard wrench. Secondly, it can be oriented in a non-linear orientation to allow use of the apparatus in areas that an elongated wrench, or wrench covered in a pipe (typical solutions for extending the reach and increasing torque of a wrench). For instance, it may be formed into a right angle or ‘L’ shape to allow for extending one's reach upwards and horizontally at the same time. In addition, the current apparatus 60 is adaptable and stable compared to other solutions, particularly other cumbersome adjustments to common wrenches that are used to exert additional torque on the wrench. Other advantages provided by the current invention become clear upon use of it in combination with wrenches, sockets, ratchets and the like.

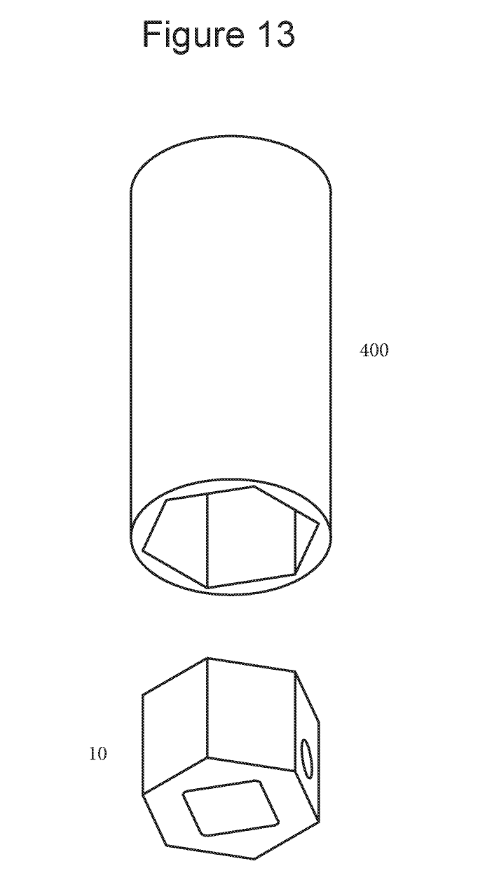

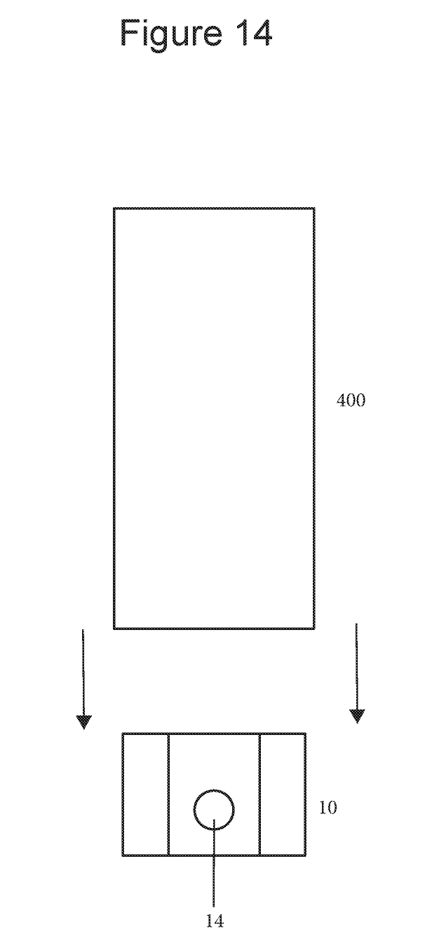

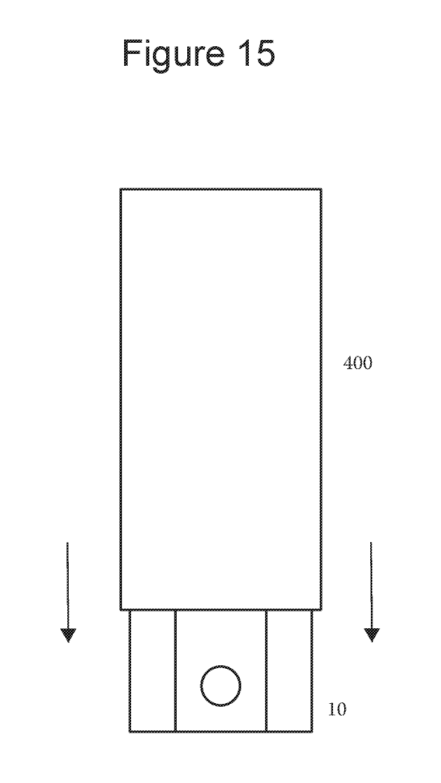

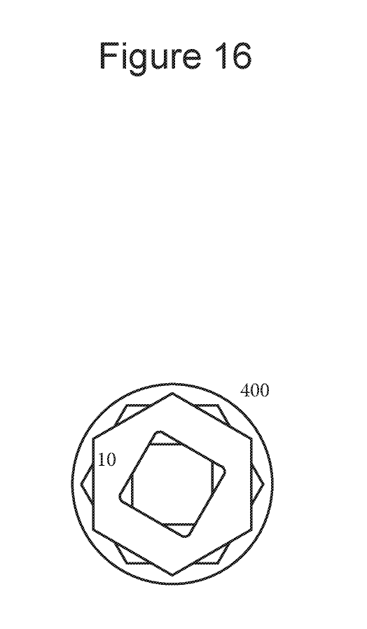

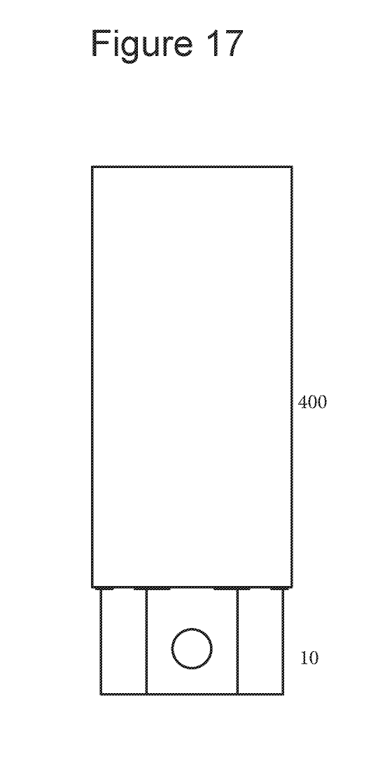

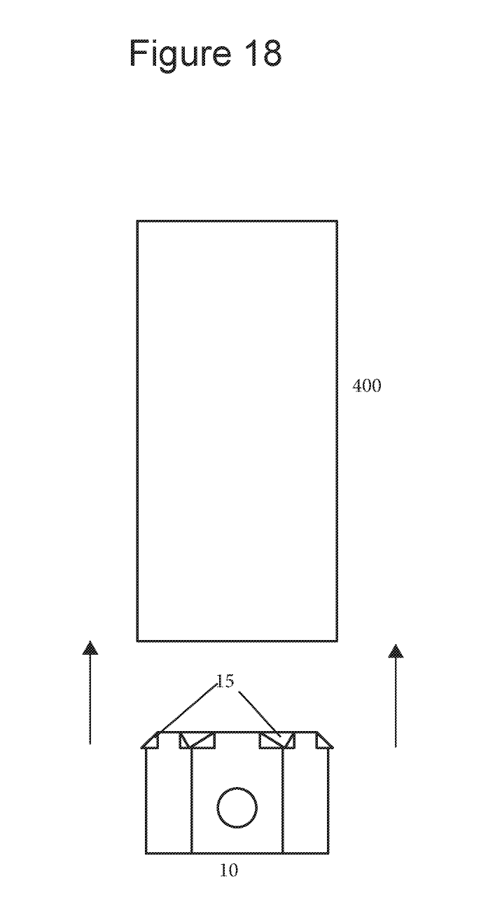

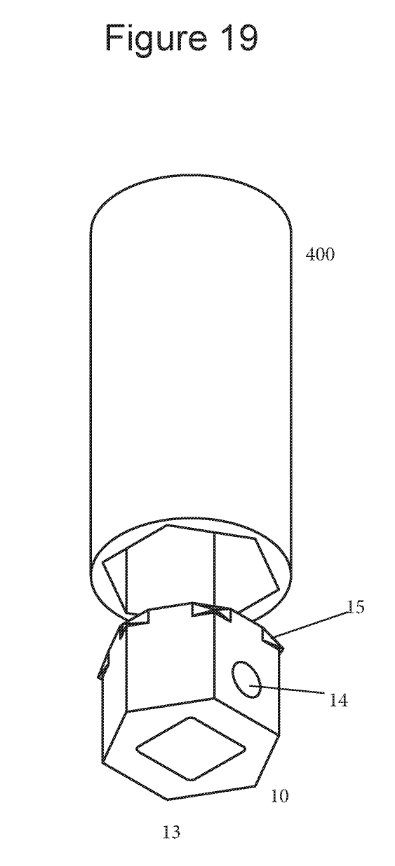

As seen in FIGS. 13-19, another contribution over the prior art pertains to the manufacture of the torque nut or tool adapter of the present invention. Although many of the aspects of the invention can be created using stainless steel, titanium, tungsten, and other similar replacement metals and fabricated using traditional methods such as CNC milling, die casting and cutting; the swaged lips or edges are an uncommon feature in metals this size. In addition, traditional die casting or forging is not particularly suitable for creating the edges as shown at 15. Thus, a novel method of manufacturing the edges is used by orienting a larger nut (400) that would fit the adapter inside (similar to a glove-and hand) (see FIG. 13) and rotating it above a certain number of degrees as shown in FIG. 16 (45° for 4 sided nuts, 30° for 6 sided nuts, 22.5° for 8 sided nuts, etc) and using a hyrdraulic press to create lips on the topside of the nuts (see, FIGS. 14-18 for an exemplary progression of the swaging process). This creates ample and uniform lips on each edge of the nut without extensive additional polishing or milling being needed (as shown in FIG. 19). In doing so nuts that work with ratchets with male adapters ranging from ⅜″ to ¾″ can easily be manufactured, with nut diameters ranging from ½″ to 2″, but occasionally larger nuts are used for certain applications.

Accordingly, although the invention has been described by reference to certain preferred and alternative embodiments, it is not intended that the novel arrangements be limited thereby, but that modifications thereof are intended to be included as falling within the broad scope and spirit of the foregoing disclosures and the appended drawings.

We claim:

1. A combination ratchet, wrench, and adapter comprising:
a ratchet, the ratchet comprising a handle and a ratcheting end, the ratcheting end comprising a male socket interface;
a wrench, the wrench being a combination wrench having one open end and one closed end; and
an adapter, the adapter comprising a nut having at least a top face, a bottom face, and at least four outer sides being perpendicular to and spanning the top face and bottom face, a centrally located female socket interface spanning the top face and the bottom face, the female socket interface matable with the male socket interface of the ratchet, the walls of the central cut being parallel to the at least four outer sides, the at least four outer sides forming parallel edges therebetween, and at least four lips located at the intersection of the top face and the parallel edges, the outer sides and parallel edges being matable with at least the closed end or the open end of the wrench; the lips protruding outwards from the edges such that the cross sectional diameter of the outermost portion of the edges is greater for the top face than the bottom face;
wherein the female socket interface of the adapter is mated with the male socket interface of the ratchet and the outer sides of the adapter are mated with one of: the open end of the wrench, or the closed end of the wrench.

2. The combination of claim 1 wherein:
the adapter comprises six, equally sized outer sides and six lips located at the intersection of the top face and the parallel edges.

3. The combination of claim 2 wherein:
the adapter is mated to the closed end of the wrench with the six sides contacting the interior portion of the closed end of the wrench and the six lips contacting the outer edge of the closed end of the wrench located opposite the ratchet, thereby preventing the wrench from sliding along an axis parallel to the sides of the adapter in the direction away from the ratchet, locking the wrench in place.

4. The combination of claim 2 wherein:
the adapter is mated to the open end of the wrench with the six sides contacting the interior portion of the open end of the wrench and the six lips contacting the outer edge of the open end of the wrench located opposite the ratchet, thereby preventing the wrench from sliding along an axis parallel to the sides of the adapter in the direction away from the ratchet, locking the wrench in place along said axis, but allowing removal of the wrench along an axis perpendicular thereof.

5. The combination of claim 1 wherein:
the male socket interface further comprises a rounded ball for locking; and
the adapter comprises at least one hole spanning at least one of the at least four outer sides to a wall of the female socket interface, the at least one hole matable to the rounded ball.

6. The combination of claim 5 wherein:
the rounded ball of the male socket interface is mated with at least one of the at least one hole of the adapter, thereby preventing rotation and slipping of the adapter with respect to the male socket interface of the ratchet; and
the adapter is mated to the closed end of the wrench with the six sides contacting the interior portion of the closed end of the wrench and the six lips contacting the outer edge of the closed end of the wrench located opposite the ratchet, thereby preventing the wrench from sliding along an axis parallel to the sides of the adapter in the direction away from the ratchet, locking the wrench in place.

7. A tool adapter comprising:
a nut having at least a top face, a bottom face, and at least four outer sides being perpendicular to and spanning the top face and bottom face;
a central rounded rectangular cut from the nut spanning the top face and the bottom face, the walls of the central cut being parallel to the at least four outer sides;
at least one hole spanning at least one of the at least four outer sides to the wall of the central cut;
the at least four outer sides forming parallel edges therebetween; and
at least four lips located at the intersection of the top face and the parallel edges, the lips protruding outwards from the edges such that the cross sectional diameter of the outermost portion of the edges is greater for the top face than the bottom face.

8. The tool adapter of claim 7 wherein:
the at least four lips are swaged.

9. The tool adapter of claim 7 comprising:
at least six outer sides and at least six lips.

10. The tool adapter of claim 9 wherein:
the at least six sides are substantially identical in size and the angles between said sides are substantially the same.

11. The tool adapter of claim 10 wherein:
the central rounded rectangular cut is a female socket interface.

12. The tool adapter of claim 9 comprising:
at least eight outer sides and at least eight lips.

13. A method for manufacturing a tool adapter comprising:
providing a six sided die cast nut having a top face and a bottom face and a female connection fitting at a centrally located location spanning between the top face and bottom face;
providing an instrument having six interior surfaces matable to the exterior sides of the six sided die cast nut;
orienting the instrument such that the interior sides of the instrument are offset from the sides of the die cast nut by approximately thirty degrees, thereby orienting the interior sides of the instrument with the edges of the six sided die cast nut;
pressing the instrument onto the top face of the die cast nut thereby swaging the six edges of the nut into lips; thereby manufacturing the tool adapter.

14. The method of manufacturing of claim 13 wherein:
the six sided nut has a hole spanning from one side of the nut to the wall of the female connection fitting.

15. The method of manufacturing of claim 14 wherein:
the female connection fitting is a rounded rectangular shape; and
the hole spans from one side of the rounded rectangle to one of the six sides of the nut.

16. The method of manufacturing of claim 13 further comprising:
milling a hole through at least one of the six sides to a side of the female connection fitting.
